(19) United States
(12) Patent Application Publication
(10) Pub. No.: US 2004/0144036 A1
(43) Pub. Date: Jul. 29, 2004

(54) Sealing profile with integrated foam rubber strip

(75) Inventors: Knut Heyden, Scheidegg (DE); Thomas Sterk, Tettnang (DE)

Correspondence Address: Stephen B. Salai, Esq., Harter, Secrest & Emery LLP, 1600 Bausch & Lomb Place, Rochester, NY, 14604-2711, US

(73) Assignee: Metzeler Automotive Profile Systems GmbH, Lindau (DE)

(21) Appl. No.: 10/706,332

(22) Filed: Nov. 12, 2003

(30) Foreign Application Priority Data
Nov. 12, 2002 (DE) 102 52 595.1

(51) Int. Cl. E06B 7/22

(52) U.S. Cl. 49/498.1

(57) ABSTRACT

A weatherseal, especially for sealing a door, a window pane or roof of a motor vehicle, is provided with a base body made of a first elastomeric material. The base body comprises a sealing portion as well as a fastening portion. The fastening portion is joined to an adhesion body defining a materially positive connection of the base body to a component. To achieve good economy by relatively cost-effective fabrication the adhesion body is made of a second elastomeric material having a cellular structure and comprising a contact surface to which an adhesive is applied. Base body and adhesion body are coextruded.

### CROSS-REFERENCE TO RELATED APPLICATIONS

This application claims priority to German Patent Application Number 102 52 595.1, filed Nov. 12, 2002.

### STATEMENT REGARDING FEDERALLY SPONSORED RESEARCH OR DEVELOPMENT

Not Applicable

### REFERENCE TO A “SEQUENCE LISTING”

Not applicable.

### BACKGROUND OF THE INVENTION

1. Field of the Invention

The invention relates to a weatherseal serving especially for sealing a door, a window pane or roof of a motor vehicle. The weatherseal is provided with a base body made of a first elastomeric material and comprising a sealing portion as well as a fastening portion. The fastening portion is joined to an adhesion body defining a material positive connection of the base body to a component.

2. Description of Related Art

One such weatherseal is described in German patent DE 37 40. 913A1. This known weatherseal serves to seal the door of a motor vehicle. For this purpose the weatherseal is secured to a surface area of the door by means of a strip of adhesive tape formulated on one side with an adhesive which is applied to the underside of the weatherseal and which needs to be stripped off prior to fitting to release the adhesive tacking to the underside of the weatherseal. The drawback with this known weatherseal is that the single-sided adhesive tape carries only one kind of adhesive whose bonding depends on the material of the components to be joined. The resulting differing cross-linking of the adhesive with the weatherseal made of an elastomeric material, on the one hand, and the door usually made of metal, on the other, may result in the weatherseal shearing off under critical strain conditions.

Known furthermore from prior art is double-sided adhesive tape (stickyback tape) formulated with two different adhesives to permit adapting to the cross-linking properties of the items to be joined. Thus, German patent DE 100 64 386 A1 discloses an adhesive tape comprising a backing provided on opposite sides with a first and a second adhesive surface. The first adhesive surface serves to secure the adhesive tape to a seal made of silicone. For this purpose the first adhesive surface is coated with a silicone adhesive cross-linking with the seal. Coated to the second adhesive surface on the opposite side is an acrylate adhesive resulting in a material positive connection with, for example, the metal or glass sunroof panel of a motor vehicle. The second adhesive surface is covered by a film which is peeled off just before the seal is mounted. The stickyback tape and seal are fabricated separately and then married to form a prefabricated assembly. In a first step in fabrication the seal is continuously extruded, and the adhesive tape is coated in a second step with the silicone adhesive. In a third step in fabrication the first adhesive surface coated with the silicone adhesive is brought into contact with the seal, whilst in a fourth step the silicone adhesive is cross-linking to the seal by being temperature and/or pressure-sensitive. In other words, securing the adhesive tape to the seal is relatively complicated and thus costly.

To simplify securing a stickyback tape to an elastomeric seal a method is proposed in EP 0 721 862 B1 in which the adhesive tape is secured to the seal on the fly prior to the seal being vulcanized into shape. This known method provides for the seal to be locally cooled in vulcanization to avoid damage by the heat materializing in vulcanization to the adhesive tape fabricated separately and made of acrylic foamed plastics, for example.

### BRIEF SUMMARY OF THE INVENTION

The invention is based on the objective of improving a weatherseal of the aforementioned kind such that is can now be fabricated relatively cost-effectively.

To achieve this objective it is provided for in a weatherseal having the features as cited above in accordance with the invention as set forth in claim 1 that the adhesion body is made of a second elastomeric material having a cellular structure and comprising a contact surface to which the adhesive is applied, base body and adhesion body being coextruded.

The weatherseal in accordance with the invention is characterized by an adhesion body integrated in the base body. Integrating the adhesion body results from coextruding base body and adhesion body in permitting continuous and thus cost-effective fabrication. The cellular structure of the second elastomeric material, from which the adhesion body is made, ensures good bonding of the adhesive applied to the contact surface of the adhesion body in thus contributing to the relatively high loading capacity of the bonded joint. The bonding of the adhesive can be enhanced by roughening the contact surface of the adhesion body prior to application of the adhesive. In other words, the costly complication of securing a separate adhesive strip to the seal is now eliminated.

Advantageous aspects of the weatherseal in accordance with the invention read from the claims 2 to 8.

Thus, it is of advantage when the second elastomeric material is cellular rubber. Cellular rubber, a rubber featuring a substantially closed-cell structure, permits uniform cross-linking of the contact surface by the adhesive in thus ensuring good bonding.

It is furthermore of advantage to formulate the first elastomeric material as a thermoplastic elastomer (TPE), ethylene-propylene dien rubber (EPDM) or a silicon-containing plastics to endow the base body and thus the sealing portion with properties such as, for example, a high thermal stability and adequate conformability ensuring a reliable seal.

Preferably the adhesive has a durable tack to facilitate mounting the weatherseal on a component, such as, for example, the frame of a door on a motor vehicle. The adhesive may be formulated as a single-component adhesive, such as, for example, of epoxy resin, or as a two-component, for example, polyurethane resin adhesive and pressure and/or temperature-sensitive depending on the particular application. To make for a practical configuration the contact surface is expediently covered by a peel-off film for facilitating handling especially with a durable tack adhesive.

Preferably the contact surface of the adhesion body protrudes from the plane of the fastening portion so that the conformable adhesion body assists in compensating irregularities between the contact surface and mounting surface of the component to which the weatherseal is to be applied, in thus practically eliminating inherent stresses in the bonded joint, resulting in a reduction in the bonding strength.

In one preferred embodiment of the weatherseal in accordance with the invention the fastening portion comprises a fastening lip assigned to the adhesion body. The fastening lip, for fastening, for example, to a door frame or a flange on the bodywork of a motor vehicle, facilitates fitting.

To achieve a good practical seal the sealing portion is configured with a hollow chamber.

### BRIEF DESCRIPTION OF THE SEVERAL VIEWS OF THE DRAWING(S)

Details and further advantages of the weatherseal in accordance with the invention will now be described by way of a preferred embodiment with reference to the drawings depicting the example embodiment merely diagrammatically in which:

FIG. 1 is a cross-section through a weatherseal;

FIG. 2 is a cross-section as shown in FIG. 1 of the weatherseal secured to a door frame.

### DETAILED DESCRIPTION OF THE INVENTION

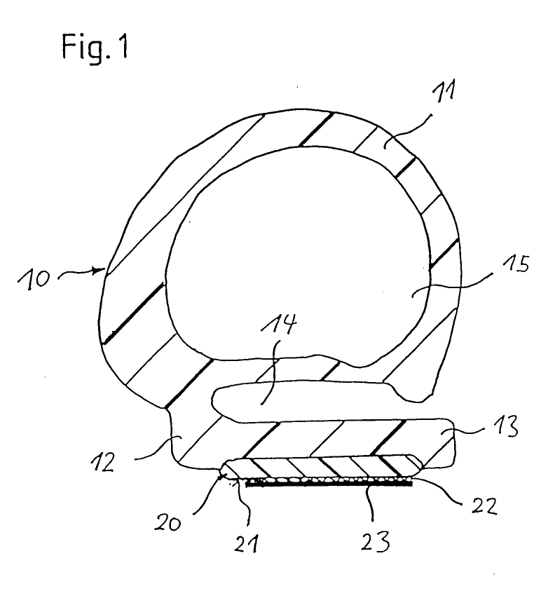

Referring now to FIG. 1 there is illustrated the weatherseal serving to seal a door relative to the bodywork of a motor vehicle. For this purpose the weatherseal comprises a base body 10 made of a first elastomeric material, for example, EPDM. The base body 10 is provided with a sealing portion 11 and a fastening portion 12. The sealing portion 11 forms a hollow chamber 15, whereas the fastening portion 12 comprises a fastening lip 13 spaced away from the sealing portion 11 by a gap 14. The gap 14 facilitates handling the weatherseal in the course of fully automated assembly, by, for example, a robotic arm engaging the gap 14 for securing the weatherseal.

The fastening portion 12 is coextruded to an adhesion body 20 arranged at the side of the fastening lip 13 opposite the gap 14. The adhesion body 20 is made of a second elastomeric material having a cellular structure, for example, cellular rubber. In addition, the adhesion body 20 comprises a contact surface 21 to which a durable-tacking adhesive 22, for example epoxy resin, is applied. The contact surface 21 is covered by a peel-off film 23 to protect the adhesive 22 as long as the weatherseal is not fitted.

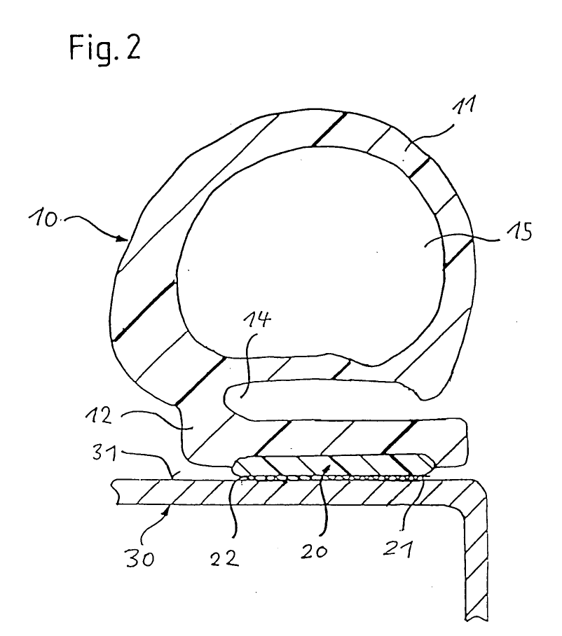

Referring now to FIG. 2 there is illustrated how the adhesion body 20 can be materially positively connected to a door frame 30 once the peel-off film 23 has been removed. The metallic door frame 30 comprises for this purpose a mounting surface 31 located opposite the contact surface 21 and joined by adhesion with the adhesive 22. The contact surface 21 protrudes from the plane of the fastening portion 12 so that irregularities between the contact surface 21 and mounting surface 31 are compensated by the conformability of the adhesion body 20 and resulting in a good bonding of the adhesive 22. In addition, the bonded joint formed by the adhesive 22 is relieved of stress in thus enhancing the shear strength and accordingly the loading capacity of the bonded joint.

The weatherseal as described above is characterized by cost-effective fabrication primarily because of the adhesion body 20 being coextruded together with the base body 10 on the fly. This ensures, on the one hand, fabrication of the weatherseal as a strip product suitable for mass production, whilst, on the other, the adhesion body 20 ensuring, because of its cellular structure, effective cross-linking with a wealth of different adhesives. This is why the adhesive 22 can be adapted to the properties of the material from which the door frame 30 is made to attain good bonding. On top of this, the contact surface 21 can now be coated on the fly with the adhesive 22 and provided with the peel-off film 23 in thus achieving relatively low production costs. This is promoted, last but not least, also by the weatherseal in accordance with the invention now making it possible to eliminate providing conventional adhesive tapes which diminish the depth of production and thus the achievable net added value.

1. A weatherseal, especially for sealing a door, a window pane or roof of a motor vehicle, including a base body made of a first elastomeric material and comprising a sealing portion as well as a fastening portion, said fastening portion being joined to an adhesion body defining a material positive connection of said base body to a component, wherein said adhesion body is made of a second elastomeric material having a cellular structure and comprising a contact surface to which an adhesive is applied, base body and adhesion body being coextruded.

2. The weatherseal as set forth in claim 1, wherein said second elastomeric material is cellular rubber.

3. The weatherseal as set forth in claim 1, wherein said first elastomeric material is a thermoplastic elastomer, ethylene-propylene dien rubber or a silicon-containing plastics.

4. The weatherseal as set forth in claim 1, wherein said adhesive is formulated for a durable tack.

5. The weatherseal as set forth in claim 1, wherein said contact surface is covered by a peel-off film.

6. The weatherseal as set forth in claim 1, wherein said contact surface of said adhesion body protrudes from the plane of said fastening portion.

7. The weatherseal as set forth in claim 1, wherein said fastening portion comprises a fastening lip on which said adhesion body is arranged.

8. The weatherseal as set forth in claim 1, wherein said sealing portion comprises a hollow chamber.
